(19) United States
(12) Patent Application Publication
(10) Pub. No.: US 2006/0118486 A1
(43) Pub. Date: Jun. 8, 2006

(54) Evaporation of water from a dilute waste slurry to produce a concentrated waste slurry

(76) Inventor: Larry P. Sower, Milford, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/005,085

(22) Filed: Dec. 6, 2004

(51) Int. Cl. C02F 9/00

(52) U.S. Cl. 210/631

(57) ABSTRACT

A system and related method for concentrating a waste slurry produced from an animal confinement housing so as to significantly reduce the volume of waste requiring treatment. The system includes means for containing a volume of waste slurry produced and flushed from an animal confinement housing, means for removing a portion of the waste slurry to produce a removed portion of waste slurry, means for selectively evaporating at least some water from the removed portion of waste slurry so as to produce a concentrated waste slurry, and optionally, means for containing the concentrated waste slurry.

### BACKGROUND OF THE INVENTION

1. The Field of the Invention

The present invention relates in general to a system for concentrating a waste slurry flushed from an animal confinement housing for raising hogs or other animals so as to significantly reduce the volume of waste to be treated or otherwise disposed of.

2. The Relevant Technology

Feedlots, animal barns, and farms that keep large numbers of animals (e.g., hogs, cattle, poultry, etc.) are sources of enormous quantities of organic waste. The disposal of untreated organic waste causes serious pollution problems. When these pollutants reach bodies of water, either because they leach from disposal sites or as a consequence of being directly released or transported into water bodies, they deoxygenate the receiving waters and impair the receiving waters' capability to support aquatic life.

Acridity and high pathogen content present additional problems of untreated waste disposal. Acrid gases released into the atmosphere are not only unpleasant but they can also contribute to acid deposition, global greenhouse effects, and ozone depletion.

Organic waste that is left to run off into adjacent bodies of water or onto adjacent land is generally high in nitrogen and phosphorous, and has been linked to various dangerous toxic microorganisms.

In hog and cattle raising operations, water is typically used to flush waste out of barns and into storage facilities, thus producing a slurry that can be up to 99.5% water. The flushed waste is typically stored in earthen lagoons. Most of the solids settle as part of a sludge layer at the bottom of the lagoon. A relatively small percentage of nutrients remain dissolved in the dilute layer, while a significant fraction of the nitrogen also volatilizes into the atmosphere.

Lagoons have a limited useful life (e.g., 25 years), and eventually must be cleaned out by completely removing the liquids along with the sludge layer prior to closure. In addition, because of the high costs and environmental disadvantages of operating large lagoons, there has recently been increased pressure to use alternative treatment techniques that either require smaller lagoons or no lagoons at all.

In an attempt to dispose of at least some of the waste while recovering some of the nutrient value of the organic waste material, a slurry of the sludge and liquid is often obtained by mixing the sludge layer with the dilute layer, and then spraying the slurry onto nearby farmland as a liquid fertilizer. Besides the fact that there is often more waste than can be safely applied to adjacent farmland, land application of waste generates offensive odors, and can also contribute to pollution of surrounding groundwater.

Because of the large volume of water used in flushing waste from animal confinement housings into lagoons (or other containing means), the volume of waste to be treated is increased substantially. The cost effectiveness of waste transportation and waste treatment methods often depends heavily on the volume of waste to be treated. It would be an improvement in the art to provide a system and method that could be used to efficiently and cost effectively concentrate the waste slurry so as to reduce the volume of waste that must be treated, while simultaneously producing a nutrient rich product which may have value as a concentrated liquid fertilizer, or which could be further processed to produce a solid, commercially marketable fertilizer product.

### BRIEF SUMMARY OF THE INVENTION

The present invention is directed to a system and related method for concentrating a waste slurry produced from an animal confinement housing so as to significantly reduce the volume of waste requiring treatment and/or disposal. The system includes means for containing a volume of waste slurry produced and removed from an animal confinement housing, means for removing a portion of dilute waste slurry from said volume of waste slurry to produce a removed portion of dilute waste slurry, means for selectively evaporating at least some water from the removed portion of dilute waste slurry so as to produce a concentrated waste slurry, and optionally, means for containing the concentrated waste slurry.

According to one embodiment, the means for containing a volume of waste slurry may comprise an anaerobic lagoon, a digester, a tank, or other container.

According to one embodiment, the means for removing a portion of dilute waste slurry from said volume of waste slurry may comprise at least one pump.

According to one embodiment, the means for selectively evaporating at least some water from the removed portion of dilute waste slurry so as to produce a concentrated waste slurry may comprise an evaporation tunnel.

According to one embodiment, the means for containing the concentrated waste slurry may comprise a brine tank.

The system may further include a heater for pre-heating the removed portion of dilute waste slurry prior to entering the evaporation tunnel. Pre-heating the waste reduces the load on the evaporation tunnel. In order to further reduce the load on the evaporation tunnel, warm exhaust air from the animal barns and/or combustion of biogas may be used to further elevate the operating temperature of the evaporation tunnel. According to one such embodiment, the evaporation tunnel may operate year round, including throughout the colder winter months.

According to one embodiment, a portion of the concentrated waste slurry may be recycled. The recycled concentrated waste slurry is mixed with the removed portion of dilute waste slurry prior to optional heating. Recycling a portion of the concentrated waste slurry provides low cost control over the temperature of the resulting mixed waste slurry being fed to the evaporation means.

If present, the exit temperature from the heater is preferably between about 70° F. and about 135° F., more preferably between about 80° F. and about 130° F., and most preferably between about 115° F. and about 125° F. Maintaining the temperature below about 135° F. may be important in some embodiments as it prevents the decomposition of ammonium bicarbonate within the waste slurry.

The system and method allows for the production of a concentrated waste slurry having a desired total solids content within a wide range. According to one embodiment, the concentrated waste slurry has a total solids content between about 10% and about 35% by weight, more preferably between about 20% and about 30% by weight, and most preferably between about 25% and about 30% by weight.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic view of a system including an exemplary embodiment of the present invention;

FIG. 2 is a perspective cut away view of an exemplary embodiment of an evaporation tunnel; and

FIG. 3 is a graph illustrating water evaporation rates as a function of waste slurry temperature.

### DETAILED DESCRIPTION OF THE PREFERRED EMBODIMENTS

I. Introduction

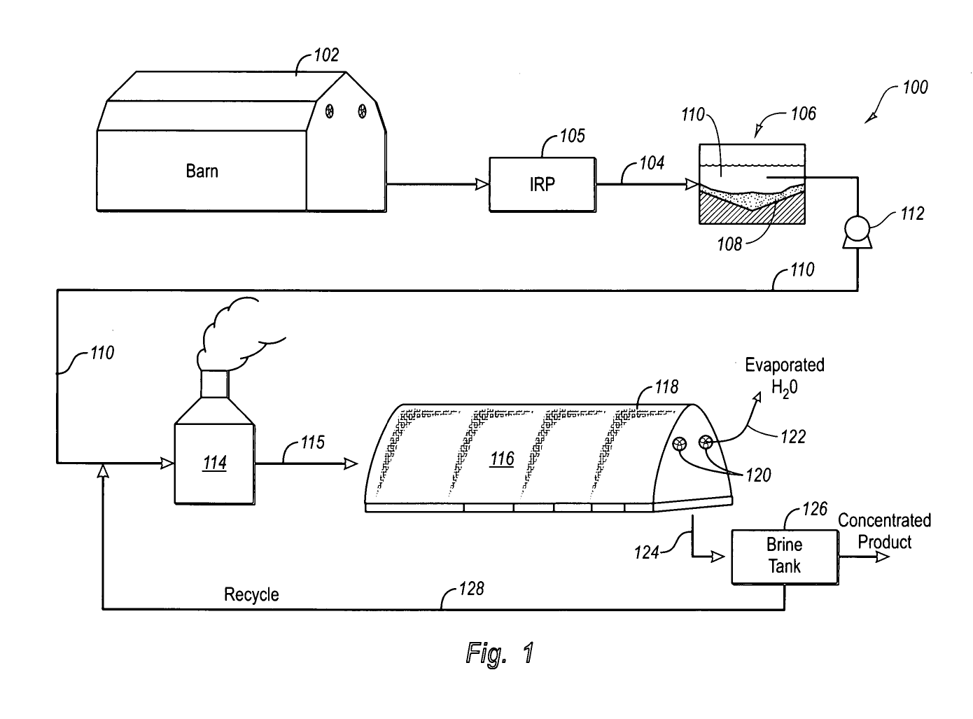

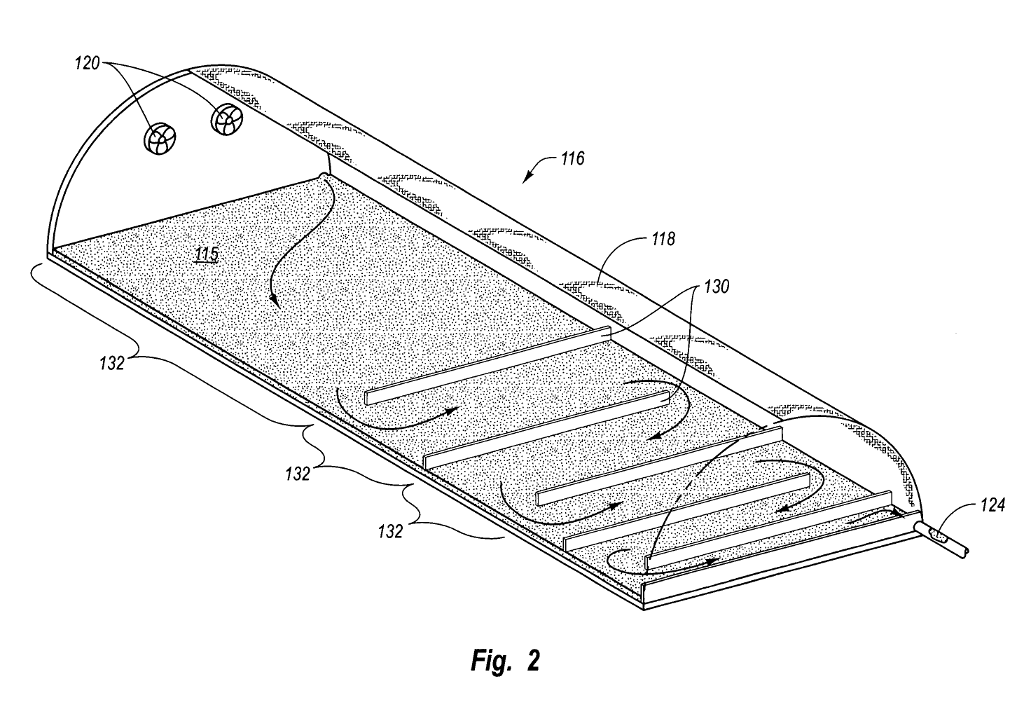

A detailed description of the invention will now be provided with specific reference to FIGS. 1 and 2 illustrating a preferred embodiment of the invention.

The present invention is directed to a system and related method for concentrating a waste slurry produced and removed (e.g., flushed) from an animal confinement housing. The system includes means for containing a volume of waste slurry produced and removed from an animal confinement housing, means for removing a portion of dilute waste slurry from the volume of waste slurry to produce a removed portion of dilute waste slurry, means for selectively evaporating at least some water from the removed portion of waste slurry so as to produce a concentrated waste slurry, and optionally, means for containing the concentrated waste slurry.

II. An Exemplary Concentrating System

In a typical hog raising operation, the waste slurry flushed or otherwise removed from the animal confinement housing may contain as much as 99.5% water. Reducing the volume of waste to be treated or disposed of is beneficial as it decreases costs associated with transportation, treatment, and disposal.

FIG. 1 illustrates an exemplary system 100 for concentrating a waste slurry 104 produced from an animal confinement housing 102. Waste slurry 104 is flushed from the animal confinement housing 102 into a digester or anaerobic lagoon 106. An internal recycle process 105 may be implemented with the animal confinement housing flushing system. Exemplary internal recycle processes are disclosed in U.S. Pat. No. 6,470,828, issued Oct. 29, 2002, and entitled ANIMAL WASTE MANAGEMENT SYSTEM AND METHOD THEREOF, and a U.S. patent application bearing attorney docket number 14789.20, filed Oct. 25, 2004, and entitled INTERNAL RECYCLE PROCESS FOR HOG WASTE, both of which are hereby incorporated by reference with respect to their disclosure of internal recycle processes. With an internal recycle process, a typical 8000 head grow/finish hog farm produces a waste slurry 104 into digester or anaerobic lagoon 106 having a flowrate of about 500 gpd. Because of the large amount of water used to flush the animal confinement housing 102, the waste slurry 104 introduced into digester or anaerobic lagoon 106 may contain as much as 99.5% water, although use of an internal recycle process helps to decrease the amount of water to as low as about 92%.

Once the waste slurry 104 is introduced to the digester or anaerobic lagoon 106, a natural separation occurs. The majority of the solids present in the waste slurry 104 settles into a sludge layer on the bottom of the digester or lagoon 106, while most of the water, suspended solids, and a portion of the soluble nutrients remain in solution or suspended above the sludge layer as a dilute waste slurry.

Within digester or anaerobic lagoon 106, waste slurry 104 separates into a sludge layer 108 and a dilute waste slurry layer 110. Pump 112 is an example of means for removing a portion of dilute waste slurry 110 from anaerobic lagoon 106. Dilute waste slurry 110 is pumped to an optional heater 114.

Optional heater 114 may be used to raise the temperature of the dilute waste slurry entering the evaporation tunnel 116. Increasing the temperature of the dilute waste slurry 110 reduces the load required of the evaporation tunnel 116. Heater 114 may be fueled on a continuous basis with biogas produced and collected from the digester or anaerobic lagoon 106. According to one embodiment (not shown), a portion of the heated dilute waste slurry 115 may be returned to digester or anaerobic lagoon 106 such that the digester or anaerobic lagoon 106 operates within a mesophyllic temperature range (e.g., about 95° F.)

According to one embodiment, a recycle stream 128 of concentrated waste slurry 124 may be mixed with the dilute waste slurry 110. Recycling a portion of the concentrated waste slurry 124 provides the system with a low cost and efficient method of controlling the temperature of the mixed waste slurry 115 exiting from heater 114. According to one embodiment, the exit temperature is maintained below about 135° F. so as to prevent or minimize decomposition of ammonium bicarbonate within the waste slurry. Maintaining this relatively low temperature results in greater nitrogen retention within the fertilizer product, which may be organically certifiable.

According to one embodiment, the exit temperature from the heater is preferably between about 70° F. and about 135° F., more preferably between about 80° F. and about 130° F., and most preferably between about 115° F. and about 125° F.

Evaporation tunnel 116 is one example of means for selectively evaporating at least some water from the removed portion of dilute waste slurry so as to produce a concentrated waste slurry. According to one embodiment, evaporation tunnel 116 may be a simple hoop structure with a cover 118 for promoting evaporation of water from dilute waste slurry 110 (or mixed waste slurry 115). Cover 118 prevents rainwater from further diluting the waste to be evaporated, and provides an increased evaporation rate as compared to an evaporator without a cover. The evaporation tunnel 116 is sized according to the required capacity.

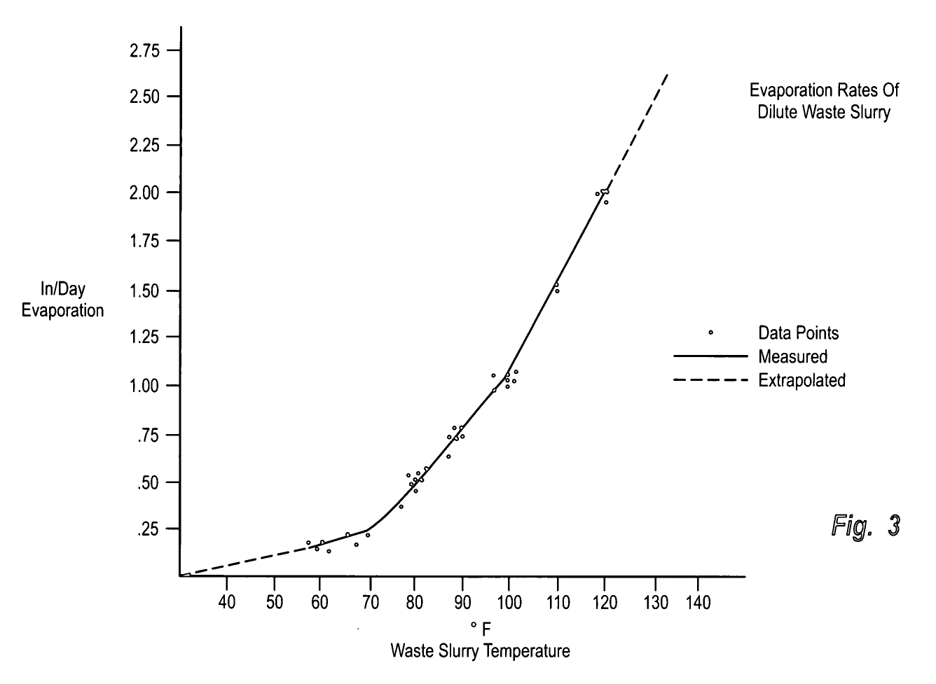

FIG. 3 illustrates evaporation rates of water from a dilute waste slurry. As can be seen, evaporation of about 0.50 inch/day may be expected with a waste slurry temperature of about 80° F., which increases rapidly to about 2.0 inches/day with a waste slurry temperature of about 120° F.

According to one embodiment, the cover 118 may be non-permeable. Use of a non-permeable cover prevents rainwater from diluting the evaporating waste slurry, while also reducing odors from the evaporation tunnel to the surrounding areas. The evaporation tunnel 116 may also include exhaust fans 120 for exhausting evaporated water 122.

According to one embodiment illustrated in FIG. 2, the evaporation tunnel 116 includes a floor covered with a polymer barrier (e.g., HDPE). The floor may be configured for a desired depth of dilute waste slurry to be evaporated. According to one embodiment, the floor is configured for the dilute waste slurry to have a depth of about 1 inch, although any depth may be used. Using a shallow depth (e.g., 1 inch) may help to further reduce odors to surrounding areas.

Evaporation tunnel 116 of FIG. 2 includes a plurality of weirs 130. Weirs 130 direct the flow of dilute waste slurry 115 and divide the evaporation tunnel into a plurality of stages 132. Each stage may be configured so as to provide an area capable of evaporating a desired percentage of the water within entering dilute waste slurry 115. For example, the first stage 132 may evaporate about 50% of the water from entering dilute waste slurry 115. The waste slurry is diverted around each weir 130, entering the next stage 132, where another fraction of the water is evaporated. Evaporation tunnel 116 may have any number of weirs and stages desired.

The evaporation tunnel may be sized and configured so as to evaporate water from the incoming waste to produce a concentrated waste slurry with any total solids content desired. Preferably, the concentrated waste slurry 124 has a total solids content between about 10% and about 35% by weight, more preferably about 20% to about 30% by weight, and most preferably about 25% to about 30% by weight.

Concentrated waste slurry 124 may be removed from the evaporation tunnel 116 and stored within brine tank 126. As described above, a portion of the concentrated waste slurry 128 may be recycled and mixed with the dilute waste slurry 110 so as to provide temperature control of the mixed waste slurry 115 entering the evaporation tunnel 116. Recycle means for recycling a portion of the concentrated waste slurry 124 may include a pump for pumping the concentrated waste slurry. The concentrated waste slurry within brine tank 126 may be sold as a high nutrient organically certifiable liquid fertilizer product, or used as a feed to more advanced fertilizer production processes. The concentrated waste slurry has a high nutrient content compared to existing organic liquid fertilizers. For example, it may have an NPK value of about 8:1:5.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A system for concentrating a waste slurry produced and removed from an animal confinement housing comprising:
means for containing a volume of waste slurry produced and removed from an animal confinement housing;
means for removing a portion of dilute waste slurry from said volume of waste slurry to produce a removed portion of dilute waste slurry; and
means for selectively evaporating at least some water from said removed portion of dilute waste slurry so as to produce a concentrated waste slurry.

2. A system as recited in claim 1, wherein said means for containing a volume of waste slurry comprises one of a digester or an anaerobic lagoon.

3. A system as recited in claim 1, wherein said means for removing a portion of dilute waste slurry from said volume of waste slurry to produce a removed portion of dilute waste slurry comprises at least one pump.

4. A system as recited in claim 1, wherein said means for selectively evaporating at least some water from said removed portion of dilute waste slurry so as to produce a concentrated waste slurry comprises an evaporation tunnel.

5. A system as recited in claim 4, wherein said evaporation tunnel includes a non-permeable cover.

6. A system as recited in claim 4, wherein said evaporation tunnel includes a plurality of weirs.

7. A system as recited in claim 4, wherein said evaporation tunnel includes a plurality of stages.

8. A system as recited in claim 1, further comprising means for containing said concentrated waste slurry, said means for containing said concentrated waste slurry comprising a brine tank.

9. A system as recited in claim 1, further comprising a heater for heating said removed portion of dilute waste slurry.

10. A system as recited in claim 9, further comprising recycle means for recycling a portion of said concentrated waste slurry from said means for containing the concentrated waste slurry to said heater so as to provide temperature control of said removed portion of dilute waste slurry.

11. A system for concentrating a waste slurry produced and removed from an animal confinement housing comprising:
at least one of a digester or an anaerobic lagoon for containing a volume of waste slurry produced and removed from an animal confinement housing;
at least one pump for removing a portion of dilute waste slurry from said digester or anaerobic lagoon to produce a removed portion of dilute waste slurry; and
an evaporation tunnel for selectively evaporating at least some water from said removed portion of dilute waste slurry so as to produce a concentrated waste slurry.

12. A method for concentrating a waste slurry produced and removed from an animal confinement housing comprising:
providing a volume of waste slurry contained within one of a digester or an anaerobic lagoon;
removing a portion of dilute waste slurry from said volume of waste slurry to produce a removed portion of dilute waste slurry; and
selectively evaporating at least some water from said removed portion of dilute waste slurry so as to produce a concentrated waste slurry.

13. A method as recited in claim 12 wherein the step of removing a portion of dilute waste slurry is performed by pumping a dilute portion of said volume of waste slurry from said digester or anaerobic lagoon.

14. A method as recited in claim 13, wherein the removed portion of dilute waste slurry is removed to an evaporation tunnel.

15. A method as recited in claim 13, wherein said portion of dilute waste slurry is passed through a heater for heating said dilute waste slurry while being pumped from said digester or anaerobic lagoon.

16. A method as recited in claim 15, further comprising recycling a portion of said concentrated waste slurry and mixing it with said portion of dilute waste slurry so as to produce a mixed waste slurry for controlling the exit temperature of the mixed waste slurry from said heater.

17. A method as recited in claim 16, wherein said exit temperature is between about 70° F. and about 135° F.

18. A method as recited in claim 16, wherein said exit temperature is between about 80° F. and about 130° F.

19. A method as recited in claim 16, wherein said exit temperature is between about 115° F. and about 125° F.

20. A method as recited in claim 12, wherein said concentrated waste slurry has a total solids content between about 10% and about 35% by weight.

21. A method as recited in claim 12, wherein said concentrated waste slurry has a total solids content between about 20% and about 30% by weight.

22. A method as recited in claim 12, wherein said concentrated waste slurry has a total solids content between about 25% and about 30% by weight.
